(19) United States
(12) Patent Application Publication
(10) Pub. No.: US 2025/0342291 A1
(43) Pub. Date: Nov. 6, 2025

(54) CONSTRUCTION METHOD OF DIGITAL TWIN SIMULATION MODEL, SORTING METHOD, ELECTRONIC DEVICE AND STORAGE MEDIUM

(71) Applicant: SF TECHNOLOGY CO., LTD., Shenzhen (CN)

(72) Inventor: Yingchun CHEN, Shenzhen (CN)

(73) Assignee: SF TECHNOLOGY CO., LTD., Shenzhen (CN)

(21) Appl. No.: 19/272,324

(22) Filed: Jul. 17, 2025

Related U.S. Application Data
(63) Continuation of application No. PCT/CN2024/083566, filed on Mar. 25, 2024.

(30) Foreign Application Priority Data
Mar. 24, 2023 (CN) 202310339466.3

(51) Int. Cl. G06F 30/20; B07C 5/36; G06F 113/20

(52) U.S. Cl. CPC G06F 30/20; B07C 5/361; G06F 2113/20

(57) ABSTRACT

The present application includes a feeding platform data model configured to fit a feeding rate distribution of a feeding platform, a gantry sorting machine data model configured to fit a parcel mis-sorting probability distribution of a gantry sorting machine, a six-sided scanner data model configured to fit a non-read rate distribution, a multi-barcode distribution, and an edge exceeding rate distribution of the six-sided scanner, and a sorting bin data model configured to fit a bin lock time distribution and a bin lock duration distribution of the sorting bin. In the present application, a reliable simulation environment and a reliable verification environment are provided, so that a sorting plan table may be verified thereby facilitating optimization of the sorting plan.

### CROSS-REFERENCE TO RELATED APPLICATIONS

This application is a continuation of International Application No. PCT/CN2024/083566, filed on Mar. 25, 2024, which claims priority to Chinese Patent Application No. 202310339466.3, filed on Mar. 24, 2023. The disclosures of the aforementioned applications are hereby incorporated by reference in their entireties.

### TECHNICAL FIELD

The present disclosure relates to the field of logistics technologies, and in particular, to a construction method of digital twin simulation model, a sorting method, an electronic device and a storage medium.

### BACKGROUND

An automated sorting process of small parcels in a logistics hub means that a parcel is transported from a feeding platform to a sorting machine trolley and then moves to a five-sided scanner with a sorting machine. The five-sided scanner scans a barcode on the parcel to obtain flow direction and delivery timeliness information of the parcel. Then, a sorting plan table is queried to obtain a destination bin of the parcel, and the sorting machine transports the parcel to the destination bin, so that the parcel falls into the destination bin to complete automated sorting.

The sorting plan table reflects a mapping relationship between a delivery timeliness type and a flow direction of the parcel and the bin, and is usually manually formulated by an experienced senior sorting plan administrator. However, due to reasons such as lack of a verification environment, a long verification periodicity, and large consumption of manpower and material resources, there is a large upper limit for optimization effect of the manually formulated sorting plan.

### SUMMARY

The present disclosure provides a digital twin simulation model that provides a construction method of a digital twin simulation model and a storage medium that is able to provide a reliable simulation environment, and is convenient for automate simulation of a to-be-simulated sorting strategy.

According to an aspect, the present disclosure provides a construction method of a digital twin simulation model. The method includes:
acquiring system body data and system historical operation data of the parcel sorting system, where the system body data includes device body data of the feeding platform, the gantry sorting machine, the six-sided scanner, and the sorting bin, and the system historical operation data includes data generated in historical operation processes of the feeding platform, the gantry sorting machine, the six-sided scanner, and the sorting bin;
constructing a system mechanism model of the parcel sorting system based on the system body data, where the system mechanism model of the parcel sorting system includes the feeding platform mechanism model, the gantry sorting machine mechanism model, the six-sided scanner mechanism model, and the sorting bin mechanism model;
constructing a system data model of the parcel sorting system based on the system historical operation data, where the system data model of the parcel sorting system includes the feeding platform data model, the gantry sorting machine data model, the six-sided scanner data model, and the sorting bin data model; and
collectively using the system mechanism model and the system data model of the parcel sorting system as the digital twin simulation model of the parcel sorting system.

In a possible implementation of the present disclosure, the method further includes:
acquiring simulation data, where the simulation data includes parcel attribute data of at least one sorted parcel and actual sorting process data generated when the parcel sorting system sorts the at least one sorted parcel;
inputting the parcel attribute data of the at least one sorted parcel to the digital twin simulation model for simulation, and outputting simulation sorting process data generated by the digital twin simulation model;
calculating a fidelity of the digital twin simulation model based on the actual sorting process data and the simulation sorting process data, to obtain a fidelity calculation result; and
updating the digital twin simulation model with an optimal fidelity as a target based on the fidelity calculation result.

In a possible implementation of the present disclosure, the actual sorting process data includes an actual parcel drop-off count and an actual parcel drop-off time interval of each sorting bin, the simulation sorting process data includes a simulated parcel drop-off count and a simulated parcel drop-off time interval of each sorting bin data model, and the calculating the fidelity of the digital twin simulation model based on the actual sorting process data and the simulation sorting process data, to obtain the fidelity calculation result includes:
(a) calculating a drop-off count fidelity of each sorting bin data model based on the actual drop-off count of each sorting bin and the simulated parcel drop-off count of each sorting bin data model;
(b) calculating a drop-off time interval fidelity of each sorting bin data model based on the actual drop-off time interval of each sorting bin and the simulated parcel drop-off time interval of each sorting bin data model;
(c) calculating a single-bin fidelity of each sorting bin data model based on the drop-off count fidelity and the drop-off time interval fidelity; and
(d) calculating a bin fidelity average value of all the sorting bin data models based on the single-bin fidelity of each sorting bin data model, and using the bin fidelity average value as the fidelity calculation result.

In a possible implementation of the present disclosure, the updating the digital twin simulation model with the optimal fidelity as the target based on the fidelity calculation result includes:
repeating the steps (a) to step (c), and traversing hyperparameters of the system data model in the digital twin simulation model, to confirm a target hyperparameter corresponding to a highest bin fidelity average value in the fidelity calculation result; and updating the digital twin simulation model based on the target hyperparameter.

In a possible implementation of the present disclosure, the method further includes:
acquiring an actual bin lock duration of each sorting bin, where the actual bin lock duration is a duration from bin lock to bin release of the sorting bin; and
updating the model construction data based on the actual bin lock duration.

In a possible implementation of the present disclosure, the method further includes:
acquiring actual manual feeding speed data of the feeding platform, where the actual manual feeding speed data is a speed at which a parcel is manually placed on the feeding platform;
and updating the model construction data based on the actual manual feeding speed data.

In a possible implementation of the present disclosure, before the digital twin simulation model of the parcel sorting system is constructed based on the model construction data, the method further includes:
performing data cleaning on the model construction data, to obtain model construction data obtained after the data cleaning; and
performing attribute check on the model construction data obtained after the data cleaning, and updating the model construction data based on an obtained attribute check result.

According to another aspect, the present disclosure provides a sorting method, applied to a parcel sorting system, where the sorting method includes: simulating a sorting strategy of the parcel sorting system by using the digital twin simulation model constructed according to the above mentioned construction method, to obtain a sorting simulation result, the sorting strategy including a sorting plan table; according to the sorting simulation result, automatically sorting, through the parcel sorting system, a parcel.

According to another aspect, the present disclosure provides an electronic device, including a memory and a processor, where the memory stores a computer program, when the computer program is loaded by the processor, steps of the sorting method mentioned above are executed.

According to another aspect, the present disclosure provides a non-volatile computer-readable storage medium, wherein the computer-readable storage medium stores a computer program, and the computer program is configured to be loaded by a processor to execute steps of the sorting method above mentioned.

According to another aspect, the present disclosure provides an electronic device including a memory and a processor, where the memory stores a computer program, when the computer program is loaded by the processor, the steps of the construction method of the digital twin simulation model above mentioned are executed.

According to another aspect, the present disclosure further provides a non-volatile computer-readable storage medium. The computer-readable storage medium stores a computer program. The computer program is configured to be loaded by a processor to execute the steps in the method for constructing the parcel sorting simulation system.

In the present disclosure, a feeding rate distribution of a feeding platform is fitted based on system historical operation data of the feeding platform by using a feeding platform data model, a parcel mis-sorting probability distribution of a gantry sorting machine is fitted based on system historical operation data of the gantry sorting machine by using a gantry sorting machine data model, a non-read rate distribution, a multi-barcode distribution, and an edge exceeding rate distribution of a six-sided scanner is fitted based on system historical operation data of the six-sided scanner by using a six-sided scanner data model, and a bin lock time distribution and a bin lock duration distribution of a sorting bin is fitted based on system historical operation data of the sorting bin by using a sorting bin data model, to form a simulation environment of a parcel sorting system. In other words, in the present disclosure, a reliable simulation environment and a reliable verification environment are provided by using a digital twin simulation model. A to-be-simulated sorting strategy of the digital twin simulation model for the parcel sorting system is simulated, to obtain a sorting simulation result. The to-be-simulated sorting strategy may include a sorting plan table, so that a sorting plan table cis verified for a plurality of times in the digital twin simulation model. In this way, verification is more efficiently performed, thereby facilitating optimization of a sorting plan table, and thus improving sorting effect of the parcel sorting system.

### BRIEF DESCRIPTION OF THE DRAWINGS

To describe the technical solutions in embodiments of the present disclosure more clearly, the drawings for describing embodiments are briefly described below. Apparently, the drawings described below show merely some of embodiments of the present disclosure, and a person skilled in the art may further derive other drawings from these drawings without creative efforts.

FIG. 1 is a schematic diagram of a digital twin simulation model according to an embodiment of the present disclosure.

FIG. 2 is a schematic diagram of a scenario of a construction system of a digital twin simulation model according to an embodiment of the present disclosure.

FIG. 3 is a schematic flowchart of an embodiment of a construction method of a digital twin simulation model according to an embodiment of the present disclosure.

FIG. 4 is a schematic structural diagram of an embodiment of a construction apparatus of a digital twin simulation model according to an embodiment of the present disclosure.

FIG. 5 is a schematic structural diagram of an embodiment of an electronic device according to an embodiment of the present disclosure.

FIG. 6 is a schematic flowchart of an embodiment of a construction method of a digital twin simulation model according to an embodiment of the present disclosure.

FIG. 7 is a schematic flowchart of an embodiment of a construction method of a digital twin simulation model according to an embodiment of the present disclosure.

### DETAILED DESCRIPTION OF THE EMBODIMENTS

The technical solutions in embodiments of the present disclosure will be described clearly and completely with reference to the accompanying drawings in embodiments of the present disclosure below. Apparently, the described embodiments are some rather than all of embodiments of the present disclosure. All other embodiments obtained by a person skilled in the art based on embodiments of the present disclosure without creative efforts will fall within the protection scope of the present disclosure.

In the descriptions of the present disclosure, it should be understood that terms “first” and “second” are merely intended for description, and shall not be understood as an indication or implication of relative importance or implicit indication of a quantity of indicated technical features. Therefore, features defined by “first” and “second” may explicitly or implicitly include one or more such features. In the descriptions of the present disclosure, “a plurality of” means two or more unless otherwise specifically stated.

In the present disclosure, the term “for example” is used for representing “giving an example, an illustration, or a description”. Any embodiment described as an “example” in the present disclosure should not be construed as being more preferred or more advantageous than other embodiments. In order that any person skilled in the art implements and uses the present disclosure, the following description is provided. In the following descriptions, details are listed for purposes of explanation. It should be noted that, a person of ordinary skill in the art may recognize that the present disclosure can be implemented without using these specific details. In other instances, well-known structures and processes are not described in detail to avoid obscure description of the present disclosure due to unnecessary details. Therefore, the present disclosure is not intended to be limited to the shown embodiments, but is consistent with the widest scope that meets the principles and the features disclosed in the present disclosure.

The following provides explanations of related terms in the present disclosure.

Digital twin: according to the digital twin technology, device data and flow data are collected by using a physical device such as a camera and a photoelectric sensor, and a digital world parallel to a real world is constructed by using data, algorithms, and simulation software in a virtual space which runs through an entire lifecycle of the real world, and provides four functions: description, diagnosis, prediction, and decision-making. A digital twin process is a process from digitalization of a physical entity to intelligentization of a digital entity. The digital twin is characterized by a high fidelity, and is able to highly fit dynamic factors of the real world. Strategies, processes, and measures are all able to be quickly evaluated and analyzed at low costs, and continuously iterated in the digital twin.

In an automated sorting process of small parcels in a logistics hub, after a destination bin of a parcel is confirmed based on a sorting plan table, the sorting plan table reflects a mapping relationship between delivery timeliness type and a flow direction of a parcel and a bin, and is usually manually formulated by experienced senior sorting plan administrators. However, due to reasons such as lack of a verification environment, a long verification periodicity, and large consumption of manpower and material resources, there is a large upper limit for optimization effect of the manually formulated sorting plan.

To resolve the foregoing problem, an embodiment of the present disclosure provides a digital twin simulation model, a construction method thereof, and a storage medium, which will be separately described in detail below.

The digital twin simulation model in the present disclosure is used for performing sorting simulation of a parcel sorting system. The parcel sorting system at least includes a feeding platform, a gantry sorting machine, a six-sided scanner, and at least one sorting bin.

Specifically, the parcel sorting system is a system used for sorting parcels in the logistics field, and the parcel sorting system includes at least one actual parcel sorting device.

Taking a parcel sorting system in an automated small parcel area of the logistics hub as an example, the parcel sorting system at least includes one real device of the feeding platform, the gantry sorting machine, the six-sided scanner, and the sorting bin. The feeding platform is a feeding device configured to provide a parcel in the parcel sorting system. A feeding manner of the feeding platform includes at least automated parcel feeding, semi-automated parcel feeding with manual assistance, and manual parcel feeding. The gantry sorting machine is a transport sorting device configured to sort a parcel from the feeding platform to a target area in the parcel sorting system. The six-sided scanner is a scanning device configured to identify and read logistics information of a parcel in the parcel sorting system. The six-sided scanner has six faces. A camera configured to identify a parcel is mounted on each of the six faces. The sorting bin is a corresponding site at which a parcel finally arrives after being sorted in the parcel sorting system.

A sorting procedure of the parcel sorting system is specifically as follows: A parcel is placed on the feeding platform manually and/or by using an automated sorting machine. The feeding platform transports the parcel to the gantry sorting machine. The six-sided scanner scans a transport form pasted on the parcel, to obtain logistics information of the parcel (including a flow direction, delivery timeliness and a label of the parcel). Then, the gantry sorting machine queries a pre-formulated sorting plan table (the sorting plan table reflects a mapping relationship between a delivery timeliness type of the parcel and a sorting bin, and a mapping relationship between flow direction of the parcel and the sorting bin), to obtain a target sorting bin at which the parcel is to arrive; and transports the parcel to the target sorting bin. Finally, the parcel falls into the bin.

It may be learned from the sorting procedure of the parcel sorting system that the sorting plan table plays a key role in the parcel sorting system and has great affect on parcel sorting effect. To ensure better sorting effect of the parcel sorting system, in the present disclosure, the digital twin simulation model of the parcel sorting system is constructed by using the digital twin technology, and a reliable verification environment used for verifying the sorting plan table is provided by using the digital twin simulation model, thereby improving optimization effect of the sorting plan table and sorting effect of the parcel sorting system.

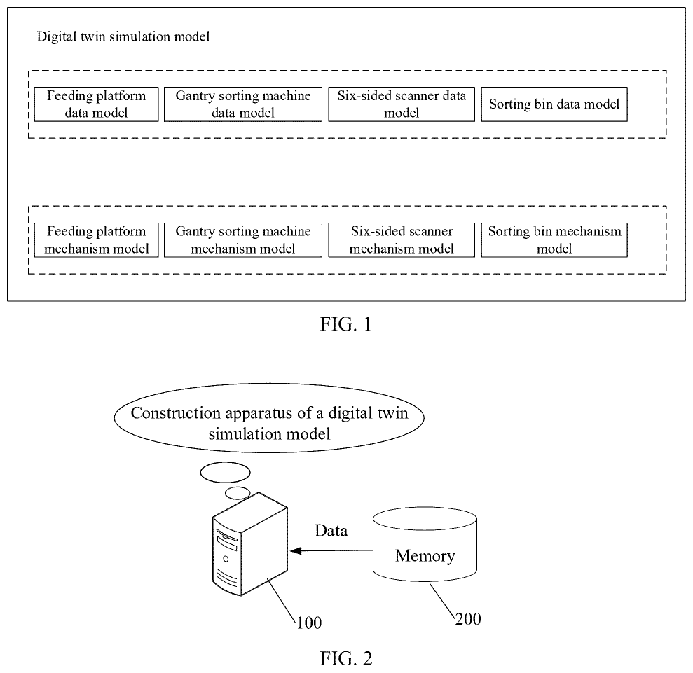

As shown in FIG. 1, the digital twin simulation model in the present disclosure includes a system data model. A system data model is a data model obtained by performing digital modeling based on information such as operation mechanisms of different types of real devices and software and control algorithms. Specifically, a system data model of the digital twin simulation model specifically includes a feeding platform data model, a gantry sorting machine data model, a six-sided scanner data model, and at least one sorting bin data model in a one-to-one correspondence with at least one sorting bin.

The feeding platform data model is configured to fit a feeding rate distribution of the feeding platform based on system historical operation data of the feeding platform.

The gantry sorting machine data model is configured to fit a parcel mis-sorting probability distribution of the gantry sorting machine based on system historical operation data of the gantry sorting machine.

The six-sided scanner data model is configured to fit a non-read rate distribution, a multi-barcode distribution, and an edge exceeding rate distribution of the six-sided scanner based on system historical operation data of the six-sided scanner.

The sorting bin data model is configured to fit a bin lock time distribution and a bin lock duration distribution of the sorting bin based on system historical operation data of the sorting bin.

In the present disclosure, a feeding rate distribution of a feeding platform is fitted based on system historical operation data of the feeding platform by using a feeding platform data model, a parcel mis-sorting probability distribution of a gantry sorting machine is fitted based on system historical operation data of the gantry sorting machine by using a gantry sorting machine data model, a non-read rate distribution, a multi-barcode distribution and an edge exceeding rate distribution of a six-sided scanner is fitted based on system historical operation data of the six-sided scanner by using a six-sided scanner data model, and a bin lock time distribution and a bin lock duration distribution of a sorting bin is fitted based on system historical operation data of the sorting bin by using a sorting bin data model, to form a simulation environment of a parcel sorting system. In other words, in the present disclosure, a reliable simulation environment and a reliable verification environment are provided by using a digital twin simulation model. A to-be-simulated sorting strategy of the digital twin simulation model for the parcel sorting system is simulated, to obtain a sorting simulation result. The to-be-simulated sorting strategy may include a sorting plan table, so that a sorting plan table is verified for a plurality of times in the digital twin simulation model. In this way, verification is more efficiently performed, thereby facilitating optimization of a sorting plan table, and thus improving sorting effect of the parcel sorting system.

The digital twin simulation model further includes a system mechanism model. The system mechanism model is a model that is constructed in virtual space through three-dimensional modeling based on geometric structures and shapes of different types of real devices, and it is in 1:1 proportional mapping with a real device. The system mechanism model of the digital twin simulation model specifically includes a feeding platform mechanism model of the feeding platform, a gantry sorting machine mechanism model of the gantry sorting machine, a six-sided scanner mechanism model of the six-sided scanner, and a sorting bin mechanism model of the sorting bin.

FIG. 2 is a schematic diagram of a scenario of a construction system of a digital twin simulation model according to an embodiment of the present disclosure. The construction system may include an electronic device 100 configured to complete a construction method of a digital twin simulation model. A construction apparatus is integrated into the electronic device 100.

In addition, as shown in FIG. 2, the construction system may further include a memory 200 configured to store data, for example, store model construction data. The model construction data includes system body data and system historical operation data of the parcel sorting system.

It should be noted that, the schematic diagram of the scenario of the construction system shown in FIG. 2 is merely an example. The construction system and the scenario described in the embodiment of the present disclosure are intended to describe the technical solutions in embodiments of the present disclosure more clearly, and do not constitute a limitation on the technical solutions provided in embodiments of the present disclosure. It may be known by a person with ordinary skill in the art that, with evolution of the construction system and emergence of new service scenarios, the technical solutions provided in the embodiments of the present disclosure are also applicable to similar technical problems.

A construction method of a digital twin simulation model provided in an embodiment of the present disclosure is described below. In the embodiment of the present disclosure, an electronic device is taken as an execution entity. To simplify and facilitate description, the execution entity is omitted in the subsequent embodiment of the method. The construction method of the digital twin simulation model includes:
acquiring system body data and system historical operation data of a parcel sorting system, where the system body data includes device body data of the feeding platform, the gantry sorting machine, the six-sided scanner and the sorting bin, and the system historical operation data includes data generated in historical operation processes of the feeding platform, the gantry sorting machine, the six-sided scanner and the sorting bin;
constructing a system mechanism model of the parcel sorting system based on the system body data, where the system mechanism model of the parcel sorting system includes a feeding platform mechanism model, a gantry sorting machine mechanism model, a six-sided scanner mechanism model and a sorting bin mechanism model;
constructing a system data model of the parcel sorting system based on the system historical operation data, where the system data model of the parcel sorting system includes a feeding platform data model, a gantry sorting machine data model, a six-sided scanner data model and a sorting bin data model; and
collectively using the system mechanism model and the system data model of the parcel sorting system as the digital twin simulation model corresponding to the parcel sorting system.

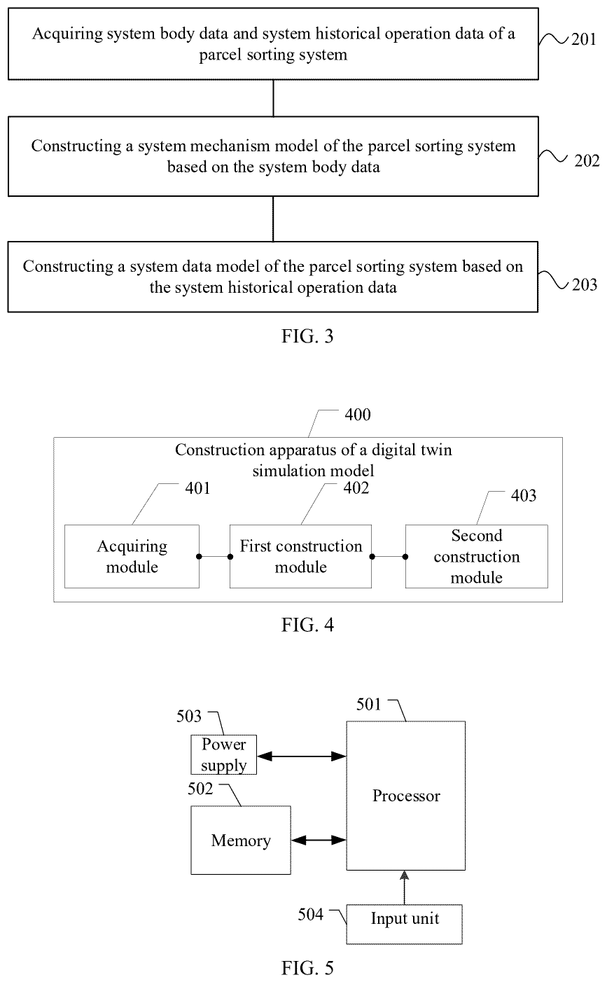

FIG. 3 is a schematic flowchart of an embodiment of a construction method of a digital twin simulation model according to an embodiment of the present disclosure. It should be noted that, although a logical sequence is shown in the flowchart, in some cases, the shown or described steps may be performed in a sequence different from the sequence herein. The construction method of the digital twin simulation model includes the following steps:

201: acquiring system body data and system historical operation data of a parcel sorting system, where the system body data includes device body data of a feeding platform, a gantry sorting machine, a six-sided scanner and a sorting bin, and the system historical operation data includes data generated in historical operation processes of the feeding platform, the gantry sorting machine, the six-sided scanner and the sorting bin.

The system body data includes device body data of different types of real devices (for example, the feeding platform, the gantry sorting machine, the six-sided scanner, and the sorting bin) in the parcel sorting system, and includes a device location, a device quantity, a device type, a length, a width, a height, a device speed, a friction coefficient, a device movement direction, a device color, and a device identity. This embodiment sets no specific limitation on a data type included in the device body data. The system historical operation data includes data in historical operation processes of different types of real devices in the parcel sorting system, for example, non-read rate data and multi-barcode data that are needed when a six-sided scanner data model is established. This embodiment sets no specific limitation on a data type included in the system historical operation data.

In this embodiment, model construction data may be stored in a pre-constructed database. This database may be a data middle office, an online shared database, or the like. A method for acquiring the model construction data may be pulling the model construction data from the database in real time in a development process, or may be periodically pulling the model construction data from the database in an offline development manner, or may be that an executor manually uploads the model construction data to a target database of the execution entity of the construction method of the digital twin simulation model.

In addition, the model construction data further includes data such as a size and a feeding rhythm of a device. Since the size and the feeding rhythm of the device do not exist in a pre-constructed database, they may be acquired through recording performed by a camera and manual statistics collection. A manner of acquiring the model construction data is not specifically limited in the embodiment.

202: constructing a system mechanism model of the parcel sorting system based on the system body data, where the mechanism model of the parcel sorting system includes the feeding platform mechanism model, the gantry sorting machine mechanism model, the six-sided scanner mechanism model, and the sorting bin mechanism model.

The system mechanism model includes attributes such as a speed, a size, a force of friction, an appearance, a texture, and a color.

Taking a parcel sorting system in an automated small parcel area as an example, in a simulation software, the system mechanism models of the feeding platform, the gantry sorting machine, the six-sided scanner and the sorting bin are respectively constructed based on the system body data of the feeding platform, the gantry sorting machine, the six-sided scanner and the sorting bin. The system mechanism model is continuously optimized to make a three-dimensional appearance of the system mechanism model keep a high fidelity as much as possible with a real device of the parcel sorting system as a target. The three-dimensional appearance of the system mechanism model includes a color, a size, a moving speed, a moving direction of a device, and the like.

In the embodiment, the simulation software includes at least one of Anylogic, unreal engine, and unity. The foregoing simulation software has functions of being capable of secondary development, connecting to a database, and importing algorithm.

The system data model of the parcel sorting system is constructed based on the system historical operation data.

The system mechanism model and the system data model of the parcel sorting system are collectively used as the digital twin simulation model corresponding to the parcel sorting system.

203: constructing a system data model of the parcel sorting system based on the system historical operation data, where the system data model of the parcel sorting system includes the feeding platform data model, the gantry sorting machine data model, the six-sided scanner data model and the sorting bin data model.

The system data model includes an operation data distribution of different types of real devices in the parcel sorting system. According to the embodiment, in the simulation software (for example, unity), by invoking an external machine learning algorithm, the system data models of the feeding platform, the gantry sorting machine, the six-sided scanner, and the sorting bin are respectively constructed based on the system historical operation data of the feeding platform, the gantry sorting machine, the six-sided scanner, and the sorting bin. The machine learning algorithm mentioned in the embodiment includes at least a polynomial fitting algorithm and a probability-based curve fitting algorithm, which is not limited by the embodiment.

A process of constructing system data models of different types of real devices will be described below with examples.

Based on the system historical operation data of the feeding platform, such as a manual feeding speed of feeding personnel, the machine learning algorithm is used for learning the manual feeding speed of the feeding personnel to fit a feeding rate distribution of the feeding platform, and then the feeding rate distribution of the feeding platform is used as the feeding platform data model.

Based on the system historical operation data of the gantry sorting machine, for example, a target sorting bin set of to-be-sorted parcels is acquired based on a code scanning result of the six-sided scanner, the to-be-sorted parcel is sorted into a sorting bin nearest to the to-be-sorted parcel according to a principle of proximity sorting through moving of a trolley, sorting logic of the gantry sorting machine is learned by using a machine learning algorithm to fit a device mis-sorting (for example, ejected parcels) probability distribution of the gantry sorting machine, and then the device mis-sorting probability distribution of the gantry sorting machine is used as the gantry sorting machine data model.

Based on the system historical operation data of the six-sided scanner, for example, the non-read rate data and the multi-barcode data of the six-sided scanner, by using the machine learning algorithm, a non-read rate distribution, a multi-barcode distribution, an edge exceeding rate distribution, and the like of the six-sided scanner are learned and fitted, and the non-read rate distribution, the multi-barcode distribution, and the edge exceeding rate distribution of the six-sided scanner are used as the six-sided scanner data model.

Based on the system historical operation data of the sorting bin, for example, a bin lock time and a bin lock duration of the sorting bin, the machine learning algorithm is used for learning and fitting a bin lock time distribution and a bin lock duration distribution of the sorting bin, and the bin lock time distribution and the bin lock duration distribution of the sorting bin are used as the sorting bin data model. When a plurality of parcels fall into the sorting bin, and a gunny bag under the sorting bin is filled up, packing personnel locks the sorting bin, and then performs operations such as printing a tag on the bag, packing, and releasing the sorting bin. When the sorting bin is locked, the sorting bin is temporarily disabled. The gantry sorting machine will receive a disable instruction of this sorting bin, and a parcel that should fall into this sorting bin is no longer sorted into this sorting bin. Instead, it is sorted into another sorting bin according to the principle of proximity sorting or moves one or more cycles on the gantry sorting machine. The gantry sorting machine performs a sorting operation after it is confirmed that the sorting bin is in an unlocked available state. Based on the system data model of the sorting bin, when the sorting bin is locked and when the sorting bin is released are mainly learned.

In the embodiment, the system data models of different types of real devices are merely for illustration purposes. Different system data models may be constructed according to actual requirements. A type of the system data model is not specifically limited in the embodiment.

The system mechanism model and the system data model of the parcel sorting system are collectively used as the digital twin simulation model of the parcel sorting system.

In the embodiment, after the digital twin simulation model is obtained through construction, a to-be-simulated sorting strategy of the parcel sorting system may be simulated by using the digital twin simulation model to obtain a sorting simulation result.

The to-be-simulated sorting strategy may be a pre-specified sorting plan table. The to-be-simulated sorting strategy of the parcel sorting system is simulated by using the digital twin simulation model to obtain the sorting simulation result specifically includes:
importing the to-be-simulated sorting strategy into the digital twin simulation model, running the digital twin simulation model, and outputting the sorting simulation result. Specifically, the sorting plan table may be imported into the simulation software for constructing the digital twin simulation model. The simulation software is run, and then a simulation report output by the simulation software is a sorting simulation result. The simulation report includes business indicators of the parcel sorting system such as a capacity of the parcel sorting system, a parcel drop-off count, a parcel sorting duration, and a parcel recirculation rate.

By constructing the digital twin simulation model of the parcel sorting system, based on a verification environment constructed by using the digital twin simulation model, the sorting plan table is simulated and verified for multiple times. The verification is more efficient and more conducive to optimization of the sorting plan table, thereby improve sorting effect of the parcel sorting system.

In a process of constructing the digital twin simulation model, to achieve a smaller difference between the sorting simulation result of the digital twin simulation model and an actual sorting result of the parcel sorting system when same input data (for example, a parcel tracking number, a delivery timeliness type, a parcel flow direction, a parcel sorting plan, and a time of placing a parcel on the feeding platform) is input, the present disclosure further proposes optimizing the digital twin simulation model by optimizing a fidelity of the digital twin simulation model.

The fidelity is a key indicator for evaluating whether a simulation model is available. Merely when the fidelity of the simulation model is high enough, quality of the sorting plan is verified in the simulation environment. In the embodiment, the fidelity of the digital twin simulation model may be specifically a difference between a sorting simulation result of the digital twin simulation model and an actual sorting result of the parcel sorting system. This difference may be expressed as, for example, a difference between a target sorting bin into which a parcel falls in a real environment and a target sorting bin into which a parcel falls in a simulation environment, and a difference between a drop-off time at which a parcel falls into a target sorting bin in a real environment and a drop-off time at which a parcel falls into a target sorting bin in a simulation environment.

The specific methods for optimizing the fidelity of the digital twin simulation model are described as follows.

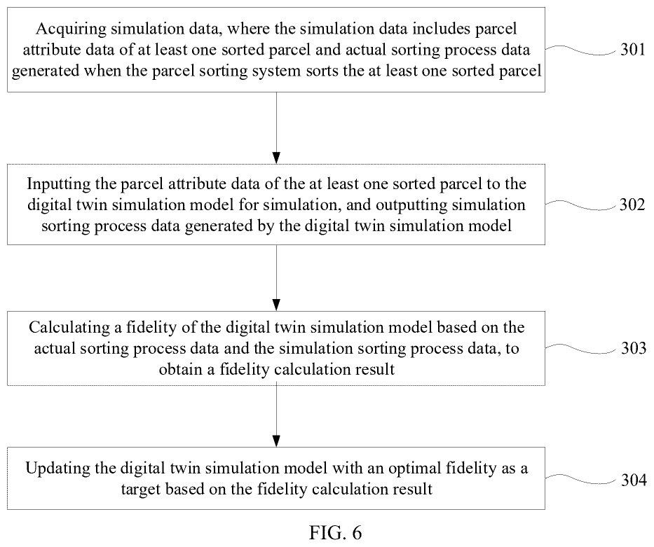

As shown in FIG. 6, in some embodiments of the present disclosure, the construction method of the digital twin simulation model further includes:

301: acquiring simulation data, where the simulation data includes parcel attribute data of at least one sorted parcel and actual sorting process data generated when the parcel sorting system sorts the at least one sorted parcel.

The simulation data includes input data input to the digital twin simulation model for simulation and verification data used for verifying a fidelity of the digital twin simulation model.

In the embodiment, the input data may include parcel attribute data of at least one sorted parcel, and the parcel attribute data may be, for example, a parcel tracking number, a delivery timeliness type, a parcel flow direction, a parcel sorting plan, and a time of placing a parcel on the feeding platform. The verification data may include actual sorting process data generated when the parcel sorting system sorts at least one sorted parcel based on same input parcel attribute data. The actual sorting process data may include, for example, an actual feeding time at which a parcel is fed on the feeding platform, an actual sorting bin that a parcel arrives after being sorted by the gantry sorting machine, an actual parcel drop-off time that a parcel falls into a sorting bin, and an actual bin lock duration of each sorting bin.

302: inputting the parcel attribute data of the at least one sorted parcel to the digital twin simulation model for simulation, and outputting simulation sorting process data generated by the digital twin simulation model.

Specifically, the parcel attribute data of the at least one sorted parcel is input into the simulation software, the simulation software is run to output the simulation sorting process data generated by the digital twin simulation model. The simulation sorting process data may, for example, include a simulated feeding time that a parcel is fed on the feeding platform, a simulation sorting bin at which a parcel arrives when being sorted by the gantry sorting machine, a simulated parcel drop-off time that a parcel falls into a sorting bin, and a simulated bin lock duration of each sorting bin.

303: calculating a fidelity of the digital twin simulation model based on the actual sorting process data and the simulation sorting process data, to obtain a fidelity calculation result.

In the embodiment, for example, the fidelity of the digital twin simulation model may be calculated based on the difference between a target sorting bin into which a parcel falls in a real environment and a target sorting bin into which a parcel falls in a simulation environment, and the difference between a drop-off time that a parcel falls into a target sorting bin in a real environment and a drop-off time that a parcel falls into a target sorting bin in a simulation environment, to obtain the fidelity calculation result.

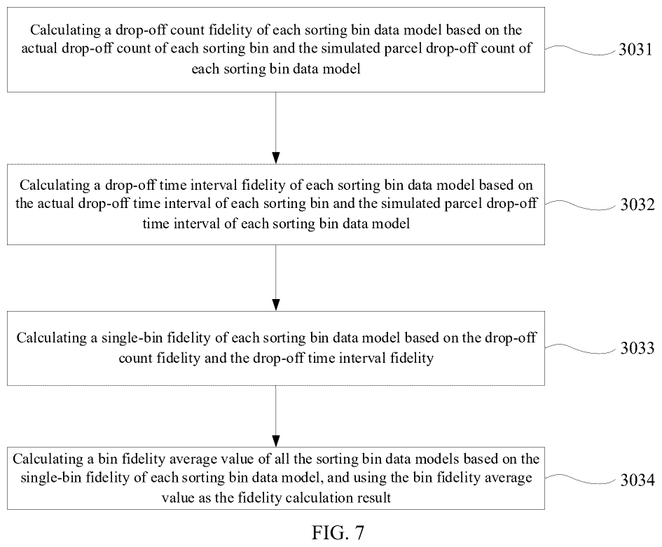

Specifically, the parcel sorting system includes at least one sorting bin, and the digital twin simulation model includes at least one sorting bin data model in a one-to-one correspondence with the at least one sorting bin. Correspondingly, the actual sorting process data may include an actual drop-off count and an actual parcel drop-off time interval of each sorting bin. The simulation sorting process data may include a simulated parcel drop-off count and a simulated parcel drop-off time interval of each sorting bin data model. As shown in FIG. 7, the calculating the fidelity of the digital twin simulation model based on the actual sorting process data and the simulation sorting process data, to obtain the fidelity calculation result may specifically include:

3031: calculating a drop-off count fidelity of each sorting bin data model based on the actual drop-off count of each sorting bin and the simulated parcel drop-off count of each sorting bin data model.

In the embodiment, calculation is performed according to a drop-off count fidelity calculation strategy, and the drop-off count fidelity calculation strategy is specifically as follows:

$${F}_{number} = {\sum }_{i = 1}^{h} \{ ( 1 - \frac{\vert {NR}_{i} - {NV}_{i} \vert}{{NR}_{i}} ) \times \frac{{NV}_{i}}{P} \} \times 100 \% .$$

Herein, F_{number} is the drop-off count fidelity; i is a label of the sorting bin or the sorting bin data model, where i=1, 2, . . . , h, and h is a quantity of statistics collection times in a shift; NRᵢ is a quantity of parcels that fall into the ith sorting bin in every n minutes in reality; NVᵢ is a quantity of parcels that fall into the ith sorting bin in every n minutes in a simulation environment; and P is a total quantity of parcels that actually fall into the ith sorting bin in a target shift.

The shift means a sorting shift of the parcel sorting system, and the shift is equivalent to a time period. This time period includes tens of minutes to several hours. In the embodiment, a start time Ts (in minutes) of the shift, an end time Te (in minutes) of the shift, and a total shift duration T are set to satisfy: Total shift duration T=End time Te−Start time Ts; and Quantity of statistics collection times in a shift h=Total shift duration T/Statistic collection interval n.

3032: calculating a drop-off time interval fidelity of each sorting bin data model based on the actual drop-off time interval of each sorting bin and the simulated parcel drop-off time interval of each sorting bin data model.

In the embodiment, calculation is performed according to a drop-off time interval fidelity calculation strategy, and the drop-off time interval fidelity calculation strategy is specifically as follows:

$${F}_{time} = {\sum }_{i = 1}^{h} ( 1 - \frac{\vert {NR}_{i} - {NV}_{i} \vert}{{NR}_{i}} ) / h \times 100 \% .$$

Herein, Fₜᵢₘₑ is the drop-off time interval fidelity; i is a label of the sorting bin or the sorting bin data model, where i=1, 2, . . . , h, and h is a quantity of statistics collection times in a shift; NRᵢ is a quantity of parcels that fall into the ith sorting bin in every n minutes in reality; and NVᵢ is a quantity of parcels that fall into the ith sorting bin in every n minutes in a simulation environment.

3033: calculating a single-bin fidelity of each sorting bin data model based on the drop-off count fidelity and the drop-off time interval fidelity.

The single-sorting-bin fidelity is at a scale of n minutes to verify a total quantity of parcels that fall into the sorting bin every n minutes in a shift. In the embodiment, calculation is performed according to a single-bin fidelity calculation strategy. The single-bin fidelity calculation strategy is specifically as follows:

$${F}_{Lat} = {F}_{time} \times 50 \% + {F}_{number} \times 50 \% .$$

Herein, F_{Lat} is a single-bin fidelity, F_{number} is a drop-off count fidelity, and Fₜᵢₘₑ is a drop-off time interval fidelity.

3034: calculating a bin fidelity average value of all the sorting bin data models based on the single-bin fidelity of each sorting bin data model, and using the bin fidelity average value as the fidelity calculation result.

In the embodiment, calculation is performed according to a bin fidelity average value calculation strategy, and the bin fidelity average value calculation strategy is specifically as follows:

$${F}_{Lataver} = {\sum }_{i = 1}^{H} {F}_{Lati} / N \times 100 \% .$$

Herein, F_{Lataver} is the bin fidelity average value, F_{Lat} is the single-bin fidelity, N is a total quantity of all sorting bins in the parcel sorting system, and i=1, 2, . . . , N.

304: updating the digital twin simulation model with an optimal fidelity as a target based on the fidelity calculation result.

In the embodiment, the highest bin fidelity average value indicates an optimal fidelity. In the embodiment, the updating the digital twin simulation model with the optimal fidelity as the target based on the fidelity calculation result specifically includes:

Repeating the step of calculating the fidelity calculation result in step 303 and traversing hyperparameters of the system data model in the digital twin simulation model, to confirm a target hyperparameter corresponding to a highest bin fidelity average value in the fidelity calculation result; and updating the digital twin simulation model based on the target hyperparameter.

The fidelity is a key indicator for evaluating whether the digital twin simulation model is available. Therefore, calculation accuracy of the fidelity is also critical. In this case, fidelity optimization needs to be performed in view of improving the fidelity. A fidelity optimization strategy mainly focuses on availability and accuracy of model construction data and simulation data and a fidelity optimization method.

In some embodiments of the present disclosure, the construction method of the digital twin simulation model further includes:

acquiring an actual bin lock duration of each sorting bin, where the actual bin lock duration is a duration from bin lock to bin release of the sorting bin; and updating the model construction data based on the actual bin lock duration.

Actual manual feeding speed data of the feeding platform is acquired. The actual manual feeding speed data is a speed that a parcel is manually placed on the feeding platform. The model construction data is updated based on the actual manual feeding speed data.

In the embodiment, since at a stage of acquiring the model construction data of the parcel sorting system, some data may be missing, which will cause incomplete model construction data stored in a database. For example, the missing data includes the actual bin lock duration of each sorting bin and the actual manual feeding speed data of the feeding platform. In the embodiment, sensors such as a camera may be used for collecting the actual bin lock duration of each sorting bin and the actual manual feeding speed data of the feeding platform, and updating the model construction data stored in the database, to improve the fidelity of the constructed digital twin simulation model.

In some embodiments of the present disclosure, the construction method of the digital twin simulation model further includes:
performing data cleaning on the model construction data to obtain model construction data obtained after the data cleaning; and performing attribute check on the model construction data obtained after the data cleaning, and updating the model construction data based on an obtained attribute check result.

In the embodiment, accuracy of the model construction data directly affects the fidelity of the constructed digital twin simulation model. Therefore, in the embodiment, after the model construction data is acquired, data cleaning may be performed on the model construction data by a manual data cleaning manner or a pre-constructed data cleaning model, to obtain the model construction data obtained after data cleaning. Attribute check is performed, by a manual attribute check manner or a pre-constructed attribute check model, on the model construction data obtained after data cleaning. The model construction data is updated based on the obtained attribute check result, to reduce missing data, misdata, and interference data in the model construction data, thereby improving accuracy of the model construction data, and thus improving the fidelity of the constructed digital twin simulation model.

According to the construction method of the digital twin simulation model provided in the present disclosure, by establishing the digital twin simulation model having a high fidelity with a real site, various constraint conditions may be introduced comprehensively from a 3D aspect and a logic aspect, to provide a verification environment having a high fidelity for verification of a sorting plan, thereby greatly reducing a verification time and costs of manpower and material resources. In addition, replicability of the digital twin simulation model is strong. Furthermore, a digital twin simulation model of another site is able to be constructed in a short period by slightly changing parameters of the constructed digital twin simulation model.

To better implement the construction method of the digital twin simulation model in the embodiments of the present disclosure, based on the construction method of the digital twin simulation model, a construction apparatus of a digital twin simulation model is further provided in embodiments of the present disclosure. As shown in FIG. 4, the construction apparatus 400 includes:
an acquiring module 401, configured to acquire system body data and system historical operation data of a parcel sorting system, where the system body data includes device body data of the feeding platform, the gantry sorting machine, the six-sided scanner, and the sorting bin, and the system historical operation data includes data generated in historical operation processes of the feeding platform, the gantry sorting machine, the six-sided scanner, and the sorting bin;
a first construction module 402, configured to construct a system mechanism model of the parcel sorting system based on the system body data, where the system mechanism model of the parcel sorting system includes the feeding platform mechanism model, the gantry sorting machine mechanism model, the six-sided scanner mechanism model, and the sorting bin mechanism model; and
a second construction module 403, configured to construct a system data model of the parcel sorting system based on the system historical operation data, where the system data model of the parcel sorting system includes the feeding platform data model, the gantry sorting machine data model, the six-sided scanner data model, and the sorting bin data model; and collectively use the system mechanism model and the system data model of the parcel sorting system as the digital twin simulation model corresponding to the parcel sorting system.

The construction apparatus 400 further includes a calculation module. The calculation module is specifically:
configured to acquire simulation data, where the simulation data includes parcel attribute data of at least one sorted parcel and actual sorting process data generated when the parcel sorting system sorts the at least one sorted parcel;
configured to input the parcel attribute data of the at least one sorted parcel to the digital twin simulation model for simulation, and output simulation sorting process data generated by the digital twin simulation model;
configured to calculate a fidelity of the digital twin simulation model based on the actual sorting process data and the simulation sorting process data, to obtain a fidelity calculation result; and
configured to update the digital twin simulation model with an optimal fidelity as a target based on the fidelity calculation result.

The actual sorting process data includes an actual drop-off count and an actual parcel drop-off time interval of each sorting bin. The simulation sorting process data includes a simulated parcel drop-off count and a simulated parcel drop-off time interval of each sorting bin data model. The calculation module is further specifically:
configured to calculate a drop-off count fidelity of each sorting bin data model based on the actual drop-off count of each sorting bin and the simulated parcel drop-off count of each sorting bin data model;
configured to calculate a drop-off time interval fidelity of each sorting bin data model based on the actual drop-off time interval of each sorting bin and the simulated parcel drop-off time interval of each sorting bin data model;
configured to calculate a single-bin fidelity of each sorting bin data model based on the drop-off count fidelity and the drop-off time interval fidelity; and
configured to calculate a bin fidelity average value of all the sorting bin data models based on the single-bin fidelity of each sorting bin data model, and use the bin fidelity average value as the fidelity calculation result.

The calculation module is further specifically:
configured to repeat the step of calculating the fidelity calculation result and traverse hyperparameters of the system data model in the digital twin simulation model, to confirm a target hyperparameter corresponding to a highest bin fidelity average value in the fidelity calculation result; and
configured to update the digital twin simulation model based on the target hyperparameter.

The construction apparatus 400 further includes a data updating module. The data updating module is specifically:
configured to acquire an actual bin lock duration of each sorting bin, where the actual bin lock duration is a duration from bin lock to bin release of the sorting bin; and
configured to update the model construction data based on the actual bin lock duration.

The data updating module is further specifically:
configured to acquire actual manual feeding speed data of the feeding platform, where the actual manual feeding speed data is a speed that a parcel is manually placed on the feeding platform; and
configured to update the model construction data based on the actual manual feeding speed data.

The construction apparatus 400 further includes a data cleaning module. The data cleaning module is specifically:
configured to perform data cleaning on the model construction data, to obtain model construction data obtained after the data cleaning; and
configured to perform attribute check on the model construction data obtained after the data cleaning, and update the model construction data based on an obtained attribute check result.

In some embodiments of the present disclosure, as shown in FIG. 5, the present disclosure further provides an electronic device. FIG. 5 is a schematic structural diagram of an electronic device according to an embodiment of the present disclosure.

The electronic device may include components such as a processor 501 of one or more processing cores, a memory 502 of one or more computer readable storage media, a power supply 503, and an input unit 504. A person skilled in the art may understand that, the structure of the electronic device shown in FIG. 5 does not constitute a limitation on the electronic device. The electronic device may include more or fewer components than those shown in the figure, or combine some components, or have different component arrangements.

The processor 501 is a control center of the electronic device, which is connected to various portions of the electronic device by using various interfaces and lines, and executes various functions of the electronic device and processes data by running or executing software programs and/or modules stored in the memory 502 and invoking data stored in the memory 502, to perform overall monitoring on the electronic device. Optionally, the processor 501 may include one or more processing cores. The processor 501 may be a central processing unit (Central Processing Unit, CPU). The processor 501 may be alternatively another general-purpose processor, a digital signal processor (Digital Signal Processor, DSP), an application-specific integrated circuit (Application Specific Integrated Circuit, ASIC), a field-programmable gate array (Field-Programmable Gate Array, FPGA) or another programmable logic device, a discrete gate or a transistor logic device, a discrete hardware component, or the like. The general-processor may be a microprocessor, or the processor may be any conventional processor or the like. Preferably, the processor 501 may be integrated with an application processor and a modem processor. The application processor mainly processes an operating system, a user interface, an application program, and the like. The modem processor mainly processes wireless communication. It may be understood that, the modem processor may alternatively not be integrated into the processor 501.

The memory 502 may be configured to store a software program and a module. The processor 501 executes various functional applications and data processing by running the software program and the module that are stored in the memory 502. The memory 502 may mainly include a program storage area and a data storage area. The program storage area may store an operating system, an application program required by at least one function (for example, a sound playing function or an image playing function), and the like. The data storage area may store data created based on use of the electronic device and the like. In addition, the memory 502 may include a high-speed random access memory, or may include a non-volatile memory, such as at least one magnetic disk storage device, a flash memory, or another volatile solid-state storage device. Correspondingly, the memory 502 may further include a memory controller, to provide the processor 501 with access to the memory 502.

The electronic device further includes a power supply 503 that supplies power to each component. Preferably, the power supply 503 may be logically connected to the processor 501 through a power management system, so as to implement functions such as charging management, discharging management, and power consumption management by using the power management system. The power supply 503 may further include one or more direct current or alternating current power supplies, a recharging system, a power supply fault detection circuit, a power supply converter or an inverter, a power supply state indicator, and any other component.

The electronic device may further include the input unit 504. The input unit 504 may be configured to receive input digit or character information, and generate a keyboard, mouse, joystick, optical, or trackball signal input related to user setting and function control.

Although not shown, the electronic device may further include a display unit and the like, and details are not described herein. Specifically, in the embodiment, the processor 501 in the electronic device loads, according to the following instructions, executable files corresponding to processes of one or more application programs into the memory 502, and the processor 501 runs the application program stored in the memory 502, to implement various functions as follows:
acquiring system body data and system historical operation data of a parcel sorting system, where the system body data includes device body data of the feeding platform, the gantry sorting machine, the six-sided scanner, and the sorting bin, and the system historical operation data includes data generated in historical operation processes of the feeding platform, the gantry sorting machine, the six-sided scanner, and the sorting bin;
constructing a system mechanism model of the parcel sorting system based on the system body data, where the system mechanism model of the parcel sorting system includes the feeding platform mechanism model, the gantry sorting machine mechanism model, the six-sided scanner mechanism model, and the sorting bin mechanism model;
constructing a system data model of the parcel sorting system based on the system historical operation data, where the system data model of the parcel sorting system includes the feeding platform data model, the gantry sorting machine data model, the six-sided scanner data model, and the sorting bin data model; and
collectively using the system mechanism model and the system data model of the parcel sorting system as the digital twin simulation model corresponding to the parcel sorting system.

A person with ordinary skill in the art may understand that all or some of the steps of the methods in the foregoing embodiments may be implemented by using an instruction, or by controlling related hardware by using an instruction. The instruction may be stored in a computer-readable storage medium, and loaded and executed by a processor.

In some embodiments of the present disclosure, the present disclosure further provides a computer-readable storage medium. The storage medium may include a read-merely memory (ROM, Read Merely Memory), a random access memory (RAM, Random Access Memory), a disk or an optical disc, and the like. The computer-readable storage medium stores a computer program. The computer program is loaded by the processor to perform the steps in the construction method of the digital twin simulation model provided in embodiments of the present disclosure. For example, the computer program is loaded by the processor to perform the following steps:
acquiring system body data and system historical operation data of a parcel sorting system, where the system body data includes device body data of the feeding platform, the gantry sorting machine, the six-sided scanner, and the sorting bin, and the system historical operation data includes data generated in historical operation processes of the feeding platform, the gantry sorting machine, the six-sided scanner, and the sorting bin;
constructing a system mechanism model of the parcel sorting system based on the system body data, where the system mechanism model of the parcel sorting system includes the feeding platform mechanism model, the gantry sorting machine mechanism model, the six-sided scanner mechanism model, and the sorting bin mechanism model;
constructing a system data model of the parcel sorting system based on the system historical operation data, where the system data model of the parcel sorting system includes the feeding platform data model, the gantry sorting machine data model, the six-sided scanner data model, and the sorting bin data model; and
collectively using the system mechanism model and the system data model of the parcel sorting system as the digital twin simulation model corresponding to the parcel sorting system.

In the foregoing embodiments, descriptions of the embodiments have different focuses. For a portion that is not described in detail in an embodiment, please refer to the foregoing detailed descriptions of other embodiments, and details are not described herein again.

The digital twin simulation model, the construction method thereof, and the storage medium provided in embodiments of the present disclosure are described in detail above. The principle and implementation of the present disclosure are described herein through specific examples. The description about embodiments of the present disclosure is merely provided to help understand the method and core ideas of the present disclosure. In addition, a person skilled in the art can make variations and modifications to the present disclosure in terms of the specific implementations and application scopes according to the ideas of the present disclosure. Therefore, the content of this specification shall not be construed as a limit to the present disclosure.

What is claimed is:

1. A construction method of a digital twin simulation model, configured to construct a digital twin simulation model, wherein the digital twin simulation model is configured to perform sorting simulation of a parcel sorting system, the parcel sorting system comprises a feeding platform, a gantry sorting machine, a six-sided scanner and at least one sorting bin, and the digital twin simulation model comprises a system mechanism model and a system data model of the parcel sorting system, the method comprises:
acquiring system body data and system historical operation data of the parcel sorting system, wherein the system body data comprises device body data of the feeding platform, the gantry sorting machine, the six-sided scanner, and the sorting bin, and the system historical operation data comprises data generated in historical operation processes of the feeding platform, the gantry sorting machine, the six-sided scanner, and the sorting bin;
constructing, based on the system body data, a system mechanism model of the parcel sorting system, wherein the system mechanism model of the parcel sorting system comprises a feeding platform mechanism model, a gantry sorting machine mechanism model, a six-sided scanner mechanism model, and a sorting bin mechanism model;
constructing, based on the system historical operation data, a system data model of the parcel sorting system, wherein the system data model of the parcel sorting system comprises a feeding platform data model, a gantry sorting machine data model, a six-sided scanner data model, and at least one sorting bin data model in a one-to-one correspondence with the at least one sorting bin; and
collectively using the system mechanism model and the system data model of the parcel sorting system as the digital twin simulation model corresponding to the parcel sorting system.

2. The construction method according to claim 1, further comprising:
(a) acquiring simulation data, wherein the simulation data comprises parcel attribute data of at least one sorted parcel and actual sorting process data generated when the parcel sorting system sorts the at least one sorted parcel;
(b) inputting the parcel attribute data of the at least one sorted parcel to the digital twin simulation model for simulation, and outputting simulation sorting process data generated by the digital twin simulation model;
(c) calculating, based on the actual sorting process data and the simulation sorting process data, a fidelity of the digital twin simulation model, to obtain a fidelity calculation result; and
(d) updating, based on the fidelity calculation result, the digital twin simulation model with an optimal fidelity as a target.

3. The construction method according to claim 2, wherein the actual sorting process data comprises an actual parcel drop-off count and an actual parcel drop-off time interval of each sorting bin, the simulation sorting process data comprises a simulated parcel drop-off count and a simulated parcel drop-off time interval of each sorting bin data model, and the calculating, based on the actual sorting process data and the simulation sorting process data, the fidelity of the digital twin simulation model to obtain the fidelity calculation result comprises:
calculating, based on the actual drop-off count of each sorting bin and the simulated parcel drop-off count of each sorting bin data model, a drop-off count fidelity of each sorting bin data model;
calculating, based on the actual drop-off time interval of each sorting bin and the simulated parcel drop-off time interval of each sorting bin data model, a drop-off time interval fidelity of each sorting bin data model;
calculating, based on the drop-off count fidelity and the drop-off time interval fidelity, a single bin fidelity of each sorting bin data model; and
calculating, based on the single bin fidelity of each sorting bin data model, a bin fidelity average value of all the sorting bin data models, and using the bin fidelity average value as the fidelity calculation result.

4. The construction method according to claim 3, wherein the updating, based on the fidelity calculation result, the digital twin simulation model with the optimal fidelity as the target comprises:
confirming, by repeating the step (a) to step (c), and traversing hyperparameters of the system data model in the digital twin simulation model, a target hyperparameter corresponding to a highest bin fidelity average value in the fidelity calculation result; and
updating, based on the target hyperparameter, the digital twin simulation model.

5. The construction method according to claim 1, further comprising:
acquiring an actual bin lock duration of each sorting bin, wherein the actual bin lock duration is a duration from bin lock to bin release of the sorting bin; and
updating, based on the actual bin lock duration, a model construction data, wherein the model construction data comprises the system mechanism model and the system data model of the parcel sorting system.

6. The construction method according to claim 5, further comprising:
acquiring actual manual feeding speed data of the feeding platform, wherein the actual manual feeding speed data is a speed at which a parcel is manually placed on the feeding platform; and
updating the model construction data based on the actual manual feeding speed data.

7. The construction method according to claim 6, further comprising:
obtaining, by performing data cleaning on the model construction data, model construction data obtained after the data cleaning; and
performing attribute check on the model construction data obtained after the data cleaning, and updating, based on an obtained attribute check result, the model construction data.

8. The construction method according to claim 1, wherein
the feeding platform data model is configured to fit a feeding rate distribution of the feeding platform based on system historical operation data of the feeding platform;
the gantry sorting machine data model is configured to fit a parcel mis-sorting probability distribution of the gantry sorting machine based on system historical operation data of the gantry sorting machine;
the six-sided scanner data model is configured to fit a non-read rate distribution, a multi-barcode distribution, and an edge exceeding rate distribution of the six-sided scanner based on system historical operation data of the six-sided scanner; and
the sorting bin data model is configured to fit a bin lock time distribution and a bin lock duration distribution of the sorting bin based on system historical operation data of the sorting bin.

9. A sorting method, applied to a parcel sorting system, comprising:
simulating a sorting strategy of the parcel sorting system by using the digital twin simulation model constructed according to the construction method of claim 1, to obtain a sorting simulation result, the sorting strategy comprising a sorting plan table; and
according to the sorting simulation result, automatically sorting, through the parcel sorting system, a parcel.

10. An electronic device, comprising a memory and a processor, wherein the memory stores a computer program, when the computer program is loaded by the processor, steps of the sorting method according to claim 9 are executed.

11. A non-transitory computer-readable storage medium, wherein the computer-readable storage medium stores a computer program, and the computer program is configured to be loaded by a processor to execute steps of the sorting method according to claim 9.

12. An electronic device, comprising a memory and a processor, wherein the memory stores a computer program, when the computer program is loaded by the processor, steps of a method of constructing a digital twin simulation model are executed, the digital twin simulation model is configured to perform sorting simulation of a parcel sorting system, the parcel sorting system comprises a feeding platform, a gantry sorting machine, a six-sided scanner and at least one sorting bin, and the digital twin simulation model comprises a system mechanism model and a system data model of the parcel sorting system, the steps of the method comprises:
acquiring system body data and system historical operation data of the parcel sorting system, wherein the system body data comprises device body data of the feeding platform, the gantry sorting machine, the six-sided scanner, and the sorting bin, and the system historical operation data comprises data generated in historical operation processes of the feeding platform, the gantry sorting machine, the six-sided scanner, and the sorting bin;
constructing, based on the system body data, a system mechanism model of the parcel sorting system, wherein the system mechanism model of the parcel sorting system comprises a feeding platform mechanism model, a gantry sorting machine mechanism model, a six-sided scanner mechanism model, and a sorting bin mechanism model;
constructing, based on the system historical operation data, a system data model of the parcel sorting system, wherein the system data model of the parcel sorting system comprises a feeding platform data model, a gantry sorting machine data model, a six-sided scanner data model, and at least one sorting bin data model in a one-to-one correspondence with the at least one sorting bin; and
collectively using the system mechanism model and the system data model of the parcel sorting system as the digital twin simulation model corresponding to the parcel sorting system.

13. The electronic device according to claim 12, wherein when the computer program is loaded by the processor, following steps of the method of constructing the digital twin simulation model are further executed:
(a) acquiring simulation data, wherein the simulation data comprises parcel attribute data of at least one sorted parcel and actual sorting process data generated when the parcel sorting system sorts the at least one sorted parcel;
(b) inputting the parcel attribute data of the at least one sorted parcel to the digital twin simulation model for simulation, and outputting simulation sorting process data generated by the digital twin simulation model;
(c) calculating, based on the actual sorting process data and the simulation sorting process data, a fidelity of the digital twin simulation model, to obtain a fidelity calculation result; and
(d) updating, based on the fidelity calculation result, the digital twin simulation model with an optimal fidelity as a target.

14. The electronic device according to claim 13, wherein the actual sorting process data comprises an actual parcel drop-off count and an actual parcel drop-off time interval of each sorting bin, the simulation sorting process data comprises a simulated parcel drop-off count and a simulated parcel drop-off time interval of each sorting bin data model, and the calculating, based on the actual sorting process data and the simulation sorting process data, the fidelity of the digital twin simulation model to obtain the fidelity calculation result comprises:
calculating, based on the actual drop-off count of each sorting bin and the simulated parcel drop-off count of each sorting bin data model, a drop-off count fidelity of each sorting bin data model;
calculating, based on the actual drop-off time interval of each sorting bin and the simulated parcel drop-off time interval of each sorting bin data model, a drop-off time interval fidelity of each sorting bin data model;
calculating, based on the drop-off count fidelity and the drop-off time interval fidelity, a single bin fidelity of each sorting bin data model; and
calculating, based on the single bin fidelity of each sorting bin data model, a bin fidelity average value of all the sorting bin data models, and using the bin fidelity average value as the fidelity calculation result.

15. The electronic device according to claim 14, wherein the updating, based on the fidelity calculation result, the digital twin simulation model with the optimal fidelity as the target comprises:
confirming, by repeating the step (a) to step (c), and traversing hyperparameters of the system data model in the digital twin simulation model, a target hyperparameter corresponding to a highest bin fidelity average value in the fidelity calculation result; and
updating, based on the target hyperparameter, the digital twin simulation model.

16. The electronic device according to claim 12, wherein when the computer program is loaded by the processor, following steps of the method of constructing the digital twin simulation model are further executed:
acquiring an actual bin lock duration of each sorting bin, wherein the actual bin lock duration is a duration from bin lock to bin release of the sorting bin; and
updating, based on the actual bin lock duration, a model construction data, wherein the model construction data comprises the system mechanism model and the system data model of the parcel sorting system.

17. The electronic device according to claim 16, wherein when the computer program is loaded by the processor, following steps of the method of constructing the digital twin simulation model are further executed:
acquiring actual manual feeding speed data of the feeding platform, wherein the actual manual feeding speed data is a speed at which a parcel is manually placed on the feeding platform; and
updating the model construction data based on the actual manual feeding speed data.

18. The electronic device according to claim 17, wherein when the computer program is loaded by the processor, following steps of the method of constructing the digital twin simulation model are further executed:
obtaining, by performing data cleaning on the model construction data, model construction data obtained after the data cleaning; and
performing attribute check on the model construction data obtained after the data cleaning, and updating, based on an obtained attribute check result, the model construction data.

19. The electronic device according to claim 12, wherein
the feeding platform data model is configured to fit a feeding rate distribution of the feeding platform based on system historical operation data of the feeding platform;
the gantry sorting machine data model is configured to fit a parcel mis-sorting probability distribution of the gantry sorting machine based on system historical operation data of the gantry sorting machine;
the six-sided scanner data model is configured to fit a non-read rate distribution, a multi-barcode distribution, and an edge exceeding rate distribution of the six-sided scanner based on system historical operation data of the six-sided scanner; and
the sorting bin data model is configured to fit a bin lock time distribution and a bin lock duration distribution of the sorting bin based on system historical operation data of the sorting bin.

20. A non-transitory computer-readable storage medium, wherein the computer-readable storage medium stores a computer program, and the computer program is configured to be loaded by a processor to execute steps of a method for constructing a digital twin simulation model,
wherein the digital twin simulation model is configured to perform sorting simulation of a parcel sorting system, the parcel sorting system comprises a feeding platform, a gantry sorting machine, a six-sided scanner and at least one sorting bin, and the digital twin simulation model comprises a system mechanism model and a system data model of the parcel sorting system, the method comprises:
acquiring system body data and system historical operation data of the parcel sorting system, wherein the system body data comprises device body data of the feeding platform, the gantry sorting machine, the six-sided scanner, and the sorting bin, and the system historical operation data comprises data generated in historical operation processes of the feeding platform, the gantry sorting machine, the six-sided scanner, and the sorting bin;
constructing, based on the system body data, a system mechanism model of the parcel sorting system, wherein the system mechanism model of the parcel sorting system comprises a feeding platform mechanism model, a gantry sorting machine mechanism model, a six-sided scanner mechanism model, and a sorting bin mechanism model;
constructing, based on the system historical operation data, a system data model of the parcel sorting system, wherein the system data model of the parcel sorting system comprises a feeding platform data model, a gantry sorting machine data model, a six-sided scanner data model, and at least one sorting bin data model in a one-to-one correspondence with the at least one sorting bin; and
collectively using the system mechanism model and the system data model of the parcel sorting system as the digital twin simulation model corresponding to the parcel sorting system.
